(19) United States
(12) Patent Application Publication
(10) Pub. No.: US 2010/0053449 A1
(43) Pub. Date: Mar. 4, 2010

(54) Video Reproducing Apparatus and Method for Controlling Illumination Device

(75) Inventor: Go Tomita, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/399,744

(22) Filed: Mar. 6, 2009

(30) Foreign Application Priority Data
Aug. 29, 2008 (JP) 2008-222630

(51) Int. Cl. H04N 5/57; H04N 9/00

(52) U.S. Cl. 348/687; 386/1; 348/E05.119

(57) ABSTRACT

According to an aspect of the present invention, there is provided, a video reproducing apparatus including: a display device configured to display a video image; an illumination device configured to apply an illumination light to the display device; and a controller configured to perform a correction process in which at least one of a brightness and a hue chromaticity of the illumination light is adjusted based on an inactivated time period during which the illumination device has been inactivated.

### CROSS-REFERENCE TO RELATED APPLICATIONS

This application is based upon and claims the benefit of priority from Japanese Patent Application No. 2008-222630, filed on Aug. 29, 2008, the entire contents of which are incorporated herein by reference.

### BACKGROUND

1. Field

An aspect of the present invention relates to a video reproducing apparatus for reproducing video which is provided by a TV broadcast or a network as well as to a method for controlling an illumination device used in such a video reproducing apparatus.

2. Description of the Related Art

In recent years, televisions using a liquid crystal panel have spread rapidly. Liquid crystal panels are employed particularly in large-screen televisions because they are lighter and thinner than CRTs.

Most of liquid crystal panels used in televisions to reproduce video using transmitted light of illumination light that is produced by a backlight which is typified by a cold-cathode tube (fluorescent tube/discharge lamp). It is therefore known that the coloring, that is, the hue (color itself), tint, and shade, of a reproduced image is varied when the luminance and/or the chromaticity of illumination light of the backlight varies. It is also known that in the cold-cathode tubes etc. which are widely used as backlights the luminance increases rapidly and the chromaticity varies in a certain period from immediately after their turning-on (i.e., application of power).

JP-2007-108285-A discloses a technique of lighting a backlight at higher brightness than a set value according to a non-lighting time if the count of a counter which measures the time from application of power is smaller than a value corresponding a standard time.

However, JP-2007-108285-A discloses only a liquid crystal display device in which the brightness is controlled according to the non-lighting time of the backlight irrespective of its lighting time.

Therefore, if the backlight is turned on immediately after turning-off, the image quality may be affected adversely as exemplified by brightness being made higher than a necessary value.

### BRIEF DESCRIPTION OF THE SEVERAL VIEWS OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 is an exemplary schematic block diagram of an example video reproducing apparatus according to an embodiment of the present invention.

FIG. 2 is an exemplary software flowchart showing a method for correcting the luminance or hue of illumination light of an illumination device for illuminating a video display device incorporated in the video reproducing apparatus of FIG. 1.

FIG. 3 is an exemplary graph showing an example method for correcting the luminance of illumination light of the illumination device.

FIG. 4 is an exemplary graph showing an example method for correcting the hue (chromaticity) of illumination light of the illumination device.

### DETAILED DESCRIPTION

Various embodiments according to the present invention will be described hereinafter with reference to the accompanying drawings. In general, according to one embodiment of the present invention, there is provided a video reproducing apparatus including: a display device configured to display a video image; an illumination device configured to apply an illumination light to the display device; and a controller configured to perform a correction process in which at least one of a brightness and a hue chromaticity of the illumination light is adjusted based on an inactivated time period during which the illumination device has been inactivated.

An embodiment of the present invention will be hereinafter described with reference to the drawings.

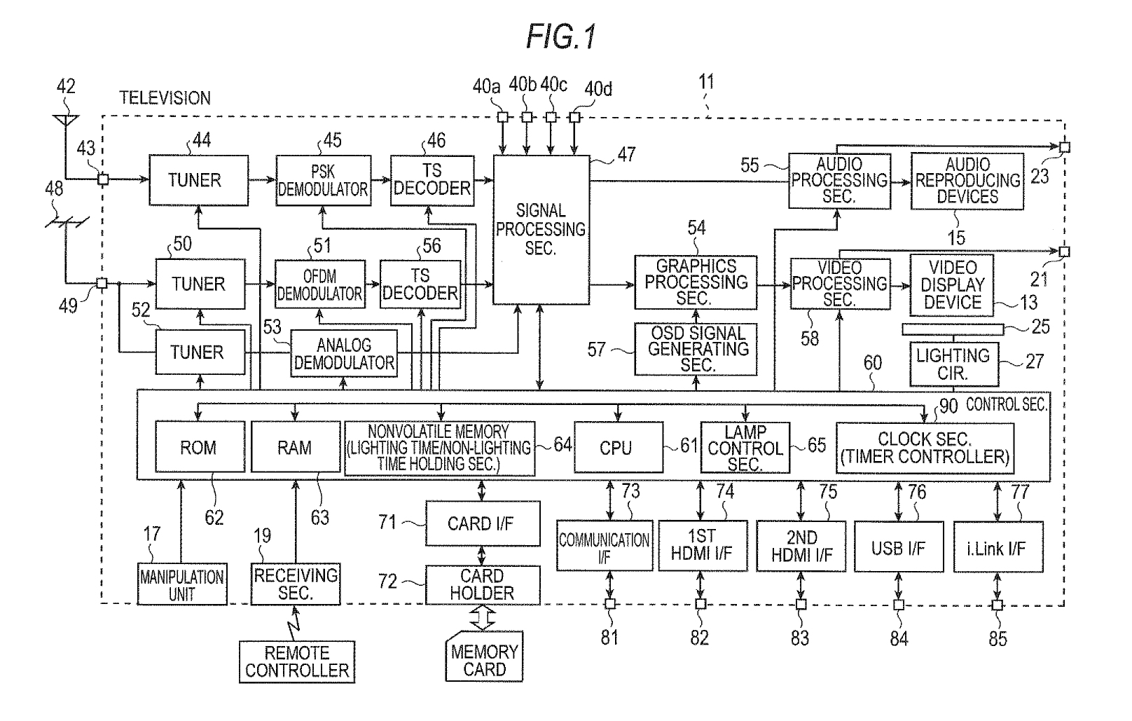

FIG. 1 shows an example video/audio reproducing apparatus according to the embodiment. The video/audio reproducing apparatus described below may be either a television provided integral with a video display device (monitor) (this type of video/audio reproducing apparatus will be hereinafter referred to as “television”) or a video/audio recording/reproducing apparatus (recorder) which can record video (moving image) and audio (audio data) and output (reproduce) the recorded video and audio.

FIG. 1 is a schematic block diagram of the video/audio reproducing apparatus (television) according to the embodiment.

The television 11 includes a video display device 13 which is typified by a liquid crystal display panel and displays video corresponding to a video signal (video data), audio reproducing devices 15 which are typified by speakers and reproduce audio (audio data), a manipulation unit 17 which receives a control instruction (control input) signal from a user, a remote control receiving section 19 which receives a user manipulation information (control input) signal transmitted from a remote controller, and a control block (control section) 60.

The video display device 13 includes a liquid crystal panel, for example, and a backlight 25 for illuminating the liquid crystal panel from behind, and reproduces (displays) video using transmission light, passing through the liquid crystal panel, of illumination light from the backlight 25. The backlight 25, which is a fluorescent tube (i.e., discharge lamp) as typified by a cold-cathode tube, outputs illumination light having given chromaticity and arbitrary brightness as the voltage supplied from a lighting circuit 27 and its pulse rate (drive frequency) are controlled. However, it is known that at low temperature the backlight 25 exhibits a large luminance variation with respect to the lighting time (drive time) and requires several dozens of minutes until the brightness (and the coloring) is stabilized.

In the television 11, the operations of the individual units and sections, the display, and the audio output are controlled by a control section (also called a control block or a main board) 60 in a unified manner.

The control section 60 incorporates a main control IC (LSI) as typified by a CPU (central control unit) 61. The control section 60 controls the individual units and sections according to the manipulation information input through the control unit 17 or through the receiving section 19.

The control section 60 also includes a ROM (read-only memory) 62 which holes control programs to be run by the CPU 61, for example, a RAM (random access memory) 63 which provides a work area for the CPU 61, and a nonvolatile memory (NVM) 64 in which various kinds of setting information, control information, etc. are stored and held.

The NVM 64 functions as a lighting time/non-lighting time holding section for holding a lighting time from turning-on to turning-off of the backlight 25 of the video display device 13 and a non-lighting time from turning-off to turning-on of the backlight 25. The NVM 64 also stores correction values for brightness to be attained when the backlight 25 is turned on, the correction value depending on the non-lighting time of the backlight 25. Usually, the brightness of the backlight 25 varies from one backlight 25 to another. Therefore, the NVM 64 additionally stores correction values for an individual variation or plural tables having different sets of correction values.

The brightness of the backlight 25 is set arbitrarily by varying the voltage and the drive pulse rate, for example, of the lighting circuit 27 with a lamp control section 65 which is provided integrally with or independently of the control section 60. The lighting circuit 27 is an inverter, for example.

The control section 60 can read a video file or an audio file from a memory card inserted in a card holder 72 via a card interface (I/F) 71 which is connected to the card holder 72, and can write a video file or an audio file to the memory card.

An arbitrary number of interfaces such as a communication interface 73, a first HDMI interface 74, a second HDMI interface 75, a USB interface 76, and an i.Link interface 77 are connected to the control section 60. The control section 60 thus functions as a control device for an external device, a hub (expansion device), or a network that is compatible with each interface. For example, the communication interface 73 is connected to a LAN terminal 81, to which a LAN-compatible external NAS (network attached storage) HDD (hard disk drive), for example, is connected. The LAN terminal 81 can be used as a general LAN-compatible port using Ethernet™. Such devices as a LAN-compatible HDD, a PC (personal computer), and a DVD recorder incorporating an HDD can be connected to the LAN terminal 81 via a hub.

The first and second HDM interfaces 74 and 75 are connected to respective HDMI terminals 82 and 83, to which a DVD recorder, an AV amplifier, or a hub (none of which are shown), for example, are connected. External devices such as an AV amplifier having an HDMI terminal, a PC, a DVD recorder incorporating an HDD, and a DVD player can be connected to the hub.

When a hub is connected to the HDMI terminal 82 or 83, connection to a network such as the Internet and reading, reproduction, writing (recording), etc. of a moving image file (video data) or an audio file (audio data) from or to a PC, a cell phone, or a PDA on the network are enabled via a broadband router, for example.

The USE interface 76 is connected to a USB port 84, to which a cell phone, a digital camera, a card reader/writer for a memory card, an HDD which can be accessed via a USB interface, a keyboard, etc. can be connected via a hub (not shown). The television 11 can thus exchange information with such individual USB devices.

The i.Link interface 77 is connected to an i.Link port 85, to which a serial connection of external devices such as an AV (audio-visual)-HDD and a D (digital)-VHS (video home system) recorder, an external ground-wave digital tuner, etc. (none of which are shown) can be connected. The television 11 can thus exchange information with arbitrary devices connected to the i.Link port 85.

Although not described in detail, a configuration is naturally possible in which a network controller that complies with the DLNA (Digital Living Network Alliance™) or the like and a Bluetooth™ interface, for example, are provided in addition to the above interfaces or in place of an arbitrary one or ones of the above interfaces and a recorder, an HDD, or a portable terminal device is connected to a corresponding terminal so as to be able to exchange data with the television 11 via them.

The control section 60 also includes a timer controller (clock section) 90. The clock section 90 manages time and such information as a reservation time (date and time) of reserved recording and a channel of a recording subject that are set according to a user input, and can hold these pieces of information. The clock section 90 can always acquire time information called TOT (time offset table) of a digital broadcast that is received via a digital tuner 50 (described later). That is, the television 11 can perform time management equivalent to that of an apparatus incorporating a radio-controlled watch. The clock section 90 can also acquire time signals at given times every day from analog broadcasts on a given channel that are received via a tuner 52 (described later).

Main signal processing systems of the television 11 will be described below.

A satellite digital TV broadcast signal that is received by a BS/CS digital broadcast receiving antenna 42 is supplied to a satellite digital broadcast tuner 44 via an input terminal 43.

The tuner 44 selects a broadcast signal on a desired channel according to a control signal from the control section 60 and outputs the selected broadcast signal to a PSK (phase shift keying) demodulator 45.

The PSK demodulator 45 demodulates the broadcast signal selected by the tuner 44 into a transport stream (TS) containing the desired program according to a control signal from the control section 60, and outputs it to a TS decoder 46.

The TS decoder 46 performs TS decoding on a signal that is multiplexed as part of the transport stream according to a control signal from the control section 60 and outputs a digital video signal and audio signal of the desired program to a signal processing section 47. Furthermore, the TS decoder 46 outputs, to the control section 60, various data (service information) that are necessary for acquiring programs (contents) transmitted by digital broadcast, electronic program guide (EPG) information, program attribute information (program genres etc.), subtitle information, etc.

A ground-wave digital TV broadcast signal received by a ground-wave broadcast receiving antenna 48 is supplied to a ground-wave digital broadcast tuner 50 via an input terminal 49.

The tuner 50 selects a broadcast signal on a desired channel according to a control signal from the control section 60 and outputs the selected broadcast signal to an OFDM (orthogonal frequency division multiplexing) demodulator 51.

The OFDM demodulator 51 demodulates the broadcast signal selected by the tuner 50 into a transport stream (TS) containing the desired program according to a control signal from the control section 60, and outputs it to a TS decoder 56.

The TS decoder 56 performs TS decoding on a signal that is multiplexed as part of the transport stream under the control of the control section 60 and outputs a digital video signal and audio signal of the desired program to the signal processing section 47. The TS decoder 56 outputs, to the control section 60, various data that are necessary for acquiring programs transmitted by digital broadcast waves, electronic program guide (EPG) information, program attribute information (program genres etc.), etc.

A ground-wave analog TV broadcast signal received by the ground-wave broadcast receiving antenna 48 is supplied to a ground-wave analog broadcast tuner 52 via the input terminal 49, whereby a broadcast signal on a desired channel is selected. The broadcast signal selected by the tuner 52 is demodulated by an analog demodulator 53 into analog content, that is, an analog video signal and audio signal, which are output to the signal processing section 47.

The signal processing section 47 performs digital signal processing selectively on the sets of a digital video signal and audio signal supplied via the PSK demodulator 45 and the OFDM demodulator 51, respectively, and outputs resulting signals to a graphics processing section 54 and an audio processing section 55, respectively.

The signal processing section 47 is connected to plural (in the illustrated example, four) input terminals 40a, 40b, 40c, and 40d. Sets of an analog video signal and audio signal from outside the television 11 can be input from the input terminals 40a-40d.

The signal processing section 47 selectively digitizes sets of an analog video signal and audio signal supplied from the analog demodulator 53 and the input terminals 40a-40d, respectively, performs digital signal processing on a resulting digital video signal and audio signal, and outputs resulting signals to the graphics processing section 54 and the audio processing section 55, respectively.

The graphics processing section 54 has a function of superimposing an OSD (on-screen display) signal generated by an OSD signal generating section 57 on a digital video signal supplied from the signal processing section 47, and outputs a resulting signal. The graphics processing section 54 can selectively output the output video signal of the signal processing section 47 and the output OSD signal of the OSD signal generating section 57 or output both of them in combination so that they will be displayed on respective halves of the screen.

The output OS signal of the OSD signal generating section 57 can be output so as to be superimposed on an ordinary picture in a semitransparent manner (i.e., so as to be transmitted through part of an ordinary picture) by setting an α blending parameter.

When a broadcast signal is accompanied by a subtitle signal and subtitles can thereby be displayed, the graphics processing section 54 performs processing of superimposing subtitle information on a video signal on the basis of a control signal from the control section 60 and the subtitle information.

A digital video signal that is output from the graphics processing section 54 is supplied to a video processing section 58. The video processing section 58 converts the digital video signal supplied from the graphics processing section 54 into an analog video signal so that video (moving image or still image) can be reproduced by the video display device 13 (monitor). Such an external device that an expansion projecting device (projector) or an external monitor may be connected to an output terminal 21 which is connected to the video processing section 58. Alternatively, for example, a DVD recorder using, as a recording medium, an optical disk that complies with the DVD standard or a video recorder using a conventional video tape as a recording medium may be connected to the output terminal 21.

The audio processing section 55, which is connected to audio reproducing devices 15 (speakers or the like), converts a digital audio signal supplied from the signal processing section 47 into an analog audio signal. Although not described in detail, it goes without saying that an audio signal (audio output) may be output, so as to be reproducible as voice or sound, to external speakers or an audio amplifier (mixer amplifier) connected to an output terminal 23 or a headphone output terminal which is provided as one form of the output terminal 23.

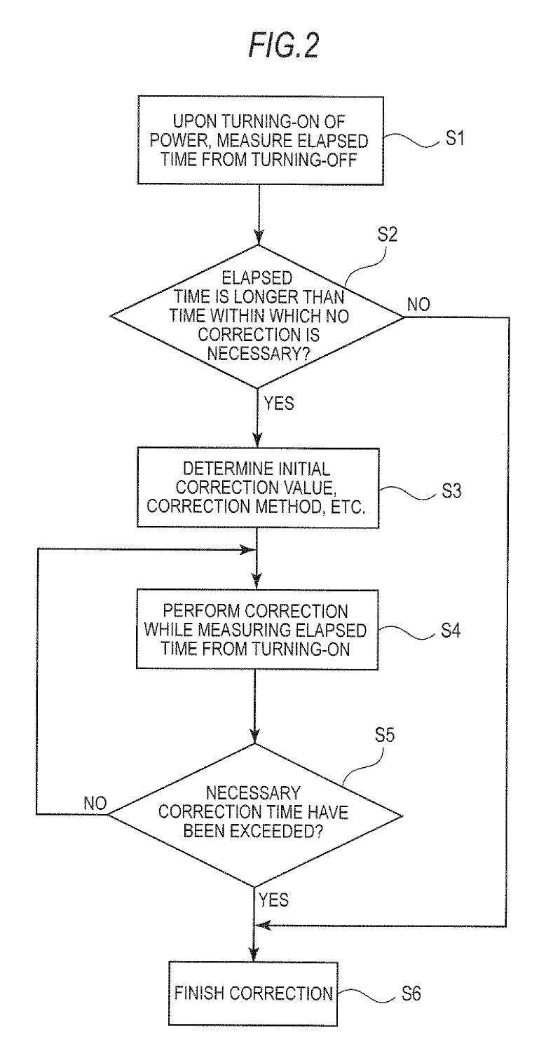

FIG. 2 shows an example method for setting luminance and chromaticity when the backlight 25 is turned on.

As described above, the quality of an image displayed by the video display device 13, that is, the coloring of a reproduced image, greatly varies depending on the non-lighting time of the backlight 25. The coloring is expressed by the hue (color itself), tint, and shade.

As described above, the luminance and the chromaticity of the backlight 25 greatly vary depending on the non-lighting time immediately before turning-on. On the other hand, after a lapse of about 30 minutes from turning-on, variation hardly occurs in the luminance and the chromaticity.

In view of the above, in turning on the backlight 25, a non-lighting time (i.e., an elapsed time in a non-lighting state) immediately before the turning-on is referred. If the elapsed time is longer than a reference time, the drive voltage supplied to the backlight 25 from the lighting circuit 27 and its pulse rate are corrected.

More specifically, as shown in FIG. 2, as soon as the panel power or the main power switch of the television 11 is turned on by manipulation of the remote controller or the manipulation unit 17 by a user, a time for which the backlight 25 of the video display device 13 has been off (i.e., a non-lighting time) is read from the NVM 64 (step S1).

For example, a non-lighting time of the backlight 25 can be acquired from the above-mentioned TOT (time information) of an immediately preceding turn-off time and a current time through calculation, from a time measurement result of the clock section 90, or from a counting result of a clock counter (not shown) or the like. When, for example, the main power is substantially off due to establishment of an energy saving mode or the like or the plug is pulled out (i.e., the television 11 is not connected to a commercial power line), a non-lighting time can be determined likewise on the basis of an interval between a last turn-off time of the backlight 25 which is held by the NVM 64 and a time of energization of the television 11, a TOT time acquired after energization, or a current time that can be acquired from a network. When the video reproducing apparatus is a personal computer (PC), for example, the ordinary OS measures an on-period and an off-period of the display device (backlight 25). Therefore, it is sufficient to merely read out a non-lighting time that is held by the NVM 64.

At step S2, it is checked whether the acquired elapsed time (non-lighting time) is longer than a time within which no luminance/chromaticity correction of the backlight 25 is necessary.

The correction value depends on not only the non-lighting time of the backlight 25 but also the lighting time immediately preceding the non-lighting period. For example, a correction control for case A that the backlight 25 is kept off for about 1 minute after lighting of several hours and then turned on again is naturally different from a correction control for case B that the backlight 25 is lit for several minutes and then kept off for more than 1 hour.

If it is detected at step S2 that the elapsed time (non-lighting time) is longer than the time within which no correction is necessary (S2: yes), at step S3 a correction initial value and a correction method are determined in view of the above points, for example.

If the situation is classified as the above-mentioned case A, the temperatures of the video display device 13 and the backlight 25 are sufficiently high and hence a correction is substantially not necessary, for example.

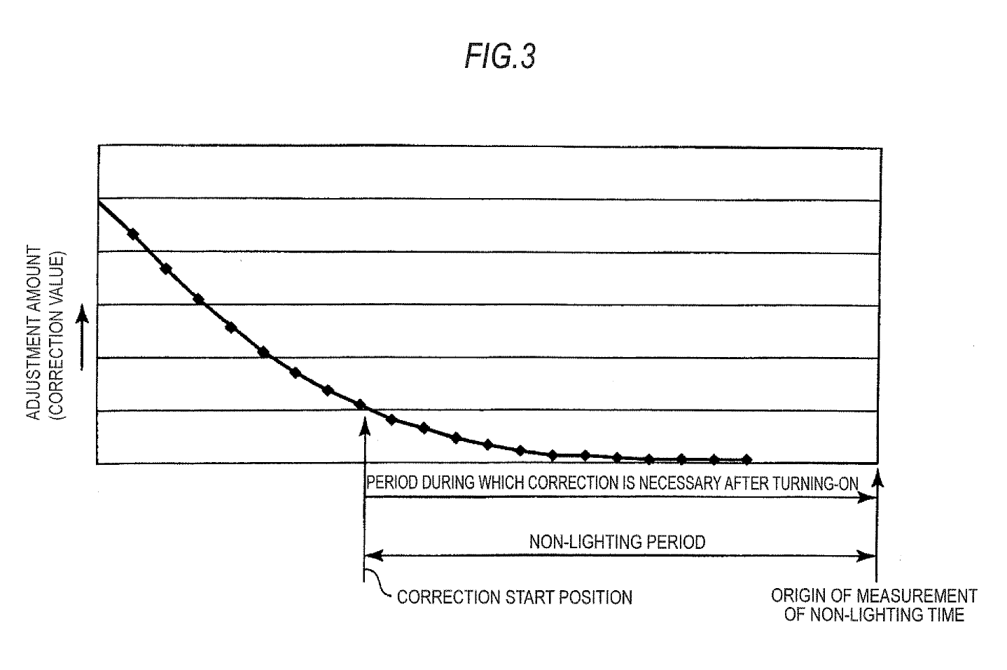

On the other hand, if the situation is classified as the above-mentioned case B, the video display device 13 and the backlight 25 should have cooled down almost fully. Therefore, as described below with reference to FIG. 3, for a certain time from turning-on, the drive voltage applied to the backlight 25 and its frequency are set higher than steady-state values (setting values or rated values) to increase the luminance of output illumination light. Naturally, if the non-lighting time is short, the initial values of the correction values are decreased accordingly.

In FIG. 3, the horizontal width indicates a maximum correction time. As the non-lighting time of the backlight 25 becomes longer, the correction start position goes leftward. The correction time from the turning-on of the backlight 25 is equal to the non-lighting time.

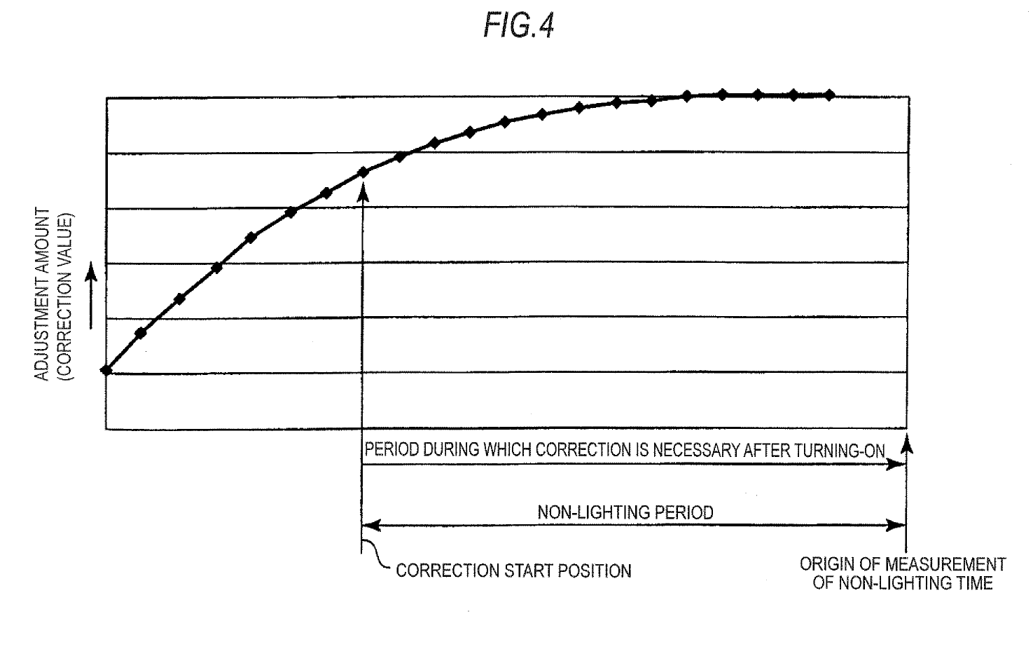

FIG. 3 shows how the drive voltage and the drive frequency are corrected (they are increased as the non-lighting time becomes longer). A hue (chromaticity) variation, which is remarkable when, for example, the temperature of the backlight 25 is lower than a reference value, is corrected in the following manner. An elapsed time from turning-off of power, that is, a non-lighting time, is measured in the same manner as described above. If the measured time is longer than a time within which the hue is not substantially influenced, the hue (chromaticity) is corrected by changing the gamma correction value in a manner shown in FIG. 4. In FIG. 4, the horizontal width indicates a maximum correction time. As the non-lighting time of the backlight 25 becomes longer, the correction start position goes leftward. The correction time from the turning-on of the backlight 25 is equal to the non-lighting time.

At step S4, the luminance and/or the hue (chromaticity) are/is corrected in the manners shown in FIGS. 3 and 4 while the elapsed time (lighting time) from the turning-on of the backlight 25 is measured.

The luminance and/or the hue (chromaticity) continue/continues to be corrected at steps S4 and S5 until the lighting time exceeds the necessary correction time (S5: yes). The correction is finished at step S6 when it becomes unnecessary.

As mentioned above, each of the liquid crystal panel and the backlight 25 of the video display device 13 has an individual variation. Therefore, the correction value that is described above with reference to FIG. 2 and is determined according to the non-lighting time and the lighting time depends on the combination of the liquid crystal panel and the backlight 25.

Although FIG. 2 is directed to the drive voltage applied to the backlight 25 and its frequency, PWM (pulse width modulation) control which varies the pulse width may be used instead of or in addition to the drive frequency control. In this case, the tube current may be varied.

The correction table that is held by the NVM 64 may be such that the correction values are correlated with the temperature of an installation environment. For example, in a low-temperature environment, the horizontal width, that is, the maximum correction time, in each of FIGS. 3 and 4 may be increased. It is also possible to increase the maximum adjustment amount (correction value) while keeping the correction time constant (common).

The embodiment can provide a video reproducing apparatus in which the illumination light of the illumination device for illuminating the video display device does not affect the image quality of displayed video.

This prevents a phenomenon that an unnecessary image quality correction is performed in displayed video when the illumination device is activated.

A variation in the image quality of displayed video can be prevented even if the illumination device is discontinuously activated and inactivated.

The invention is not limited to the embodiment, and various modifications are possible without departing from the spirit and scope of the invention. Part of the embodiment may be omitted, and the omission may provide various advantages.

What is claimed is:

1. A video reproducing apparatus comprising:
a display device configured to display a video image;
an illumination device configured to apply an illumination light to the display device; and
a controller configured to perform a correction process in which at least one of a brightness and a hue chromaticity of the illumination light is adjusted based on an inactivated time period during which the illumination device has been inactivated.

2. The video reproducing apparatus according to claim 1,
wherein, when the illumination device is activated, the controller determines whether the inactivated time period is larger than a reference time period, and
wherein, when the inactivated time period is larger than the reference time period, the controller adjusts at least one of a drive voltage of the illumination device, a pulse frequency of the drive voltage, and a pulse width of the drive voltage until the brightness of the illumination light reaches a standard level.

3. The video reproducing apparatus according to claim 2,
wherein the controller determines, based on the inactivated time period, a correction parameter that is to be adjusted in the correction process and a correction amount that is to be used in the correction process.

4. The video reproducing apparatus according to claim 2,
wherein the controller acquires a correction time period during which the correction process is to be performed, and
wherein the controller stops the correction process when the correction time period is elapsed.

5. The video reproducing apparatus according to claim 2,
wherein the controller acquires an activated time period during which the illumination device has been activated immediately prior to the inactivated time period, and
wherein the controller determines a correction time period during which the correction process is to be performed based on the inactivated time period and the activated time period.

6. The video reproducing apparatus according to claim 2,
wherein, when the inactivated time period is smaller than a reference time period, the controller does not perform the correction process.

7. A method for controlling an illumination device that illuminates an illumination light to a display device, the method comprising:
acquiring an inactivated time period of the illumination device when the illumination device is activated;
determining a correction amount for the illumination light based on the inactivated time period; and
adjusting the illumination light based on the correction amount.
